(19) United States
(12) Patent Application Publication
(10) Pub. No.: US 2020/0303709 A1
(43) Pub. Date: Sep. 24, 2020

(54) BATTERY AND METHOD FOR PRODUCING A BATTERY

(71) Applicant: Robert Bosch GmbH, Stuttgart (DE)

(72) Inventors: Jochen Schweinbenz, Stuttgart (DE); Markus Kohlberger, Stuttgart (DE)

(21) Appl. No.: 16/087,741

(22) PCT Filed: Feb. 13, 2017
(86) PCT No.: PCT/EP2017/053138

§ 371 Date: Sep. 24, 2018

(30) Foreign Application Priority Data
Mar. 22, 2016 (DE) 10 2016 204 681.0

(51) Int. Cl. H01M 2/20; H01M 2/10; H01M 10/0525; H01R 11/28; H01M 2/26

(52) U.S. Cl. CPC H01M 2/206; H01M 2/1077; H01M 2220/20; H01R 11/288; H01M 2/266; H01M 10/0525

(57) ABSTRACT

The invention relates to a battery having at least two battery modules (1, 101, 102), wherein each battery module (1, 101, 102) comprises a plurality of battery cells (2), in particular lithium-ion battery cells, which are interconnected electrically in series and/or parallel, and further has a positive voltage tap (5) and a negative voltage tap (6), wherein a first module connecting element (7) is electrically conductively connected to the positive voltage tap (5) and/or a second module connecting element (8) is electrically conductively connected to the negative voltage tap (6) and one module connecting element (7, 8) of a first battery module (101) and one module connecting element (7, 8) of a second battery module (102) are electrically conductively connected. The electrically conductive connection of the module connecting elements (7, 8) is in the form of a plug connection.

### BACKGROUND OF THE INVENTION

The invention is based on a battery. The present invention also provides a method for producing such a battery.

It is known from the prior art that batteries used as drive batteries in hybrid, plug-in hybrid and electric vehicles, such as, in particular, lithium-ion batteries, are of a modular structure, i.e. are composed of a plurality of battery modules. Furthermore, a battery module preferably has a multiplicity of individual battery cells that are interconnected to form the battery module, the individual battery cells being able to be interconnected in series or in parallel. The voltage taps of the individual battery cells such as, in particular, lithium-ion battery cells, lithium-polymer battery cells or lead acid accumulators, in this case are electrically connected to each other by means of so-called cell connectors. The cell connectors in this case are attached to the voltage taps of the individual battery cells via screwed, welded or riveted connections. Furthermore, the battery modules of the battery are also electrically connected to each other in series and/or in parallel by means of connecting elements, termed module connectors, that are attached by a screwed, welded or riveted connection. A plurality of battery modules form so-called sub-units of the battery, which share, for example, a common cooling means. A battery is usually constructed from at least two sub-units.

In the construction of a battery, special contact protection measures are required in the case of voltages of 60 volts d.c. and above, such that only trained electricians are permitted to perform work on the battery in the case of such voltages.

Known from the prior art, from DE 10 2012 215 205 A1, is a cell connector that interconnects two battery cells of differing battery modules.

Furthermore, known from DE 10 2012 215 495 is a series connection having a battery cell for adjusting a characteristic quantity of the battery cell.

### SUMMARY OF THE INVENTION

The battery, and the method for producing such a battery, having the characterizing features of the invention, have the advantage that two battery modules of a battery can be electrically connected to each other in a simple and reliable manner by a plug-in connection. It is thereby possible, in particular, to reduce the extent of work during production, since it is possible to dispense with the welded, riveted or screwed connections known from the prior art.

According to the invention, a battery having at least two battery modules is provided. A battery module in this case comprises, respectively, a plurality of battery cells that are interconnected electrically in series and/or in parallel. The battery cells in this case are, in particular, lithium-ion battery cells. In addition, a battery module has a positive voltage tap and a negative voltage tap. In this case, a first module connecting element is connected in an electrically conductive manner to the positive voltage tap, and/or a second module connecting element is connected in an electrically conductive manner to the negative voltage tap. A module connecting element of a first battery module and a module connecting element of a second battery module are connected in an electrically conductive manner. The electrically conductive connection of the module connecting elements in this case is realized as a plug-in connection.

The measures stated in the dependent claims render possible advantageous developments and improvements of the device specified in the independent claim or of the method specified in the independent claim.

It is expedient if the module connecting elements are directly connected to each other in an electrically conductive manner. It is thereby possible, during the construction of the battery, to arrange the first battery module and the second battery module at their position inside the battery and, by realizing the plug-in connection, to connect the module connecting element of the first battery module and the module connecting element of the second battery module to each other in an electrically conductive manner, with the result that no further production steps are subsequently needed in order to realize the electrically conductive connection.

It is furthermore also expedient if a further electrically conductive connecting element connects the module connecting elements to each other in an electrically conductive manner. It is thereby possible, during the construction of the battery, to arrange the first battery module and the second battery module at their position inside the battery, without in this case realizing an electrically conductive connection between the battery modules. A battery composed of a plurality of battery modules can therefore be constructed without the battery modules in this case already being electrically interconnected in series and/or in parallel, and thus there is no occurrence of elevated voltages that are above the voltages of the individual battery modules, such that there is no need for special contact protection measures if the voltage of a battery module is below the permissible voltage of 60 volts d.c. After the mechanical construction of the battery has been completed by the arrangement of the individual battery modules, building-up of the voltage can be effected. This is to be understood to mean that the individual battery modules are connected to each other in an electrically conductive manner. In particular, it is to be understood to mean that a module connecting element of the first battery module and a module connecting element of the second battery module are connected are connected to each other in an electrically conductive manner, wherein a further electrically conductive connecting element connects the module connecting elements to each other in an electrically conductive manner.

According to one embodiment of the invention, for the purpose of interconnecting the first battery module and the second battery module in series, the first module connecting element of the first battery module and the second module connecting element of the second battery module are connected in an electrically conductive manner. Furthermore, according to the one embodiment of the invention, for the purpose of interconnecting the first battery module and the second battery module in series, the second module connecting element of the first battery module and the first module connecting element of the second battery module may also be connected in an electrically conductive manner. As a result, a positive voltage tap and a negative voltage tap, or a negative voltage tap and positive voltage tap, are connected in an electrically conductive manner, such that a serial interconnection of the battery modules is realized.

According to another embodiment of the invention, for the purpose of interconnecting the first battery module and the second battery module in parallel, the first module connecting element of the first battery module and the first module connecting element of the second battery module are connected in an electrically conductive manner. Furthermore, according to the other embodiment of the invention, for the purpose of interconnecting the first battery module and the second battery module in parallel, the second module connecting element of the first battery module and the second module connecting element of the second battery module may also be connected in an electrically conductive manner. As a result, a positive voltage tap is connected in an electrically conductive manner to a positive voltage tap, or a negative voltage tap is connected in an electrically conductive manner to a negative voltage tap, such that a parallel interconnection of the battery modules is realized.

In particular, a battery module in each case has substantially two end faces, two side faces, one battery-module underside and one battery-module upper side. The two end faces are arranged opposite each other, and preferably parallel to each other. Furthermore, the two side faces are arranged opposite each other, and preferably parallel to each other. The battery-module underside and the battery-module upper side are arranged opposite each other, and preferably parallel to each other. In particular, one of the two end faces and one of the two side faces are arranged at right angles in relation to each other. Furthermore, in particular, one of the two end faces and the battery-module underside or the battery-module upper side are arranged at right angles in relation to each other. In particular, one of the two side faces and the battery-module underside or the battery-module upper side are arranged at right angles in relation to each other. The positive voltage tap and/or the negative voltage tap of the battery module are/is preferably arranged on the battery-module upper side. Furthermore, the cell connectors that electrically connect the plurality of battery cells to each other in series and/or in parallel are also arranged on the battery-module upper side. It is expedient in this case if the first module connecting element and/or the second module connecting element are/is arranged on the battery-module underside, on one of the two end faces or on one of the two side faces. It is thereby possible for a module connecting element not to be arranged on the battery-module upper side, on which the cell connectors for series and/or parallel interconnection of the individual battery cells are usually also arranged, such that safety can be increased in construction of the battery. Furthermore, as described in the following, it is thereby possible to improve the accessibility of the module connecting elements.

It is advantageous if the first battery module and the second battery module are arranged next to each other, one of the two end faces of the first battery module being arranged directly adjacently to one of the two end faces of the second battery module, and in addition the first module connecting element and/or the second module connecting element being arranged on a side face. It is thereby possible to arrange the first battery module and the second battery module inside a battery, having a plurality of battery modules, in which the plurality of battery modules are also arranged, for example, in a plurality of planes over one another, without already interconnecting the battery modules when they are being arranged. In this case, the final interconnection of the battery modules, and thus the building-up of the voltage, can be effected by means of the further electrically conductive connecting element only after the arrangement of the battery modules, since the module connecting elements are still arranged in an accessible manner even after the mechanical construction of the battery. Battery modules arranged in a plurality of planes over one another, is to be understood here to means that the battery-module upper side of at least one battery module and the battery-module underside of another battery module are arranged directly adjacently to each other. Clearly, it is also possible, if the first battery module and the second battery module are arranged next to each other, one of the two end faces of the first battery module being arranged directly adjacently to one of the two end faces of the second battery module, to attach the first module connecting element and/or the second module connecting element also to the battery-module underside or to the battery-module upper side, should the plurality of battery modules of the battery be arranged in the same plane, and a side face of one battery module thus also be arranged directly adjacently to a side face of another battery module.

In addition it is advantageous if the first battery module and the second battery module are arranged next to each other, one of the two side faces of the first battery module being arranged directly adjacently one of the two side faces of the second battery module, and furthermore the first module connecting element and/or the second module connecting element being arranged on an end face. It is thereby possible, in the case of a battery in which battery modules, such as have just been described, are arranged, for example, in a plurality of planes over each other, and two battery modules, in particular, are each arranged with one of the two side faces directly adjacent to each other, that the building-up of the voltage can be performed only after the mechanical construction of the battery, since the module connecting elements are still accessible. Furthermore, in this case it is also conceivable, in the case of the battery modules being arranged in a plane, for the first module connecting element and/or the second module connecting element to be attached to the battery-module upper side or to the battery-module underside, since the module connecting elements are still accessible, even after the mechanical construction of the battery.

Furthermore, it is also advantageous if the first battery module and the second battery module are arranged next to each other, the battery-module upper side of the first battery module being arranged directly adjacently to the battery-module underside of the second battery module, and in addition the first module connecting element and/or the second module connecting element being arranged on one of the two end faces or on one of the two side faces. It is thereby possible to arrange the first battery module and the second battery module in mutually superimposed planes of a battery having a plurality of battery modules, and to connect them in an electrically conductive manner only after the mechanical arrangement of the battery modules. In particular, the electrically conductive connection may be realized as a plug-in connection of the first module connecting element and of the second module connecting element, by means of the further electrically conductive connecting element.

Owing to the advantageous possibilities that have just been described, for arranging the first module connecting element and/or the second module connecting element on one of the two end faces, on one of the two side faces or on the battery-module underside, or in particular also on the battery-module upper side, a battery having a plurality of battery modules can be provided in a simple and safe manner. The plurality of battery modules in this case can be arranged over one another in a plurality of planes, and a plurality of battery modules can also be arranged in each plane. It is preferred in this case to first arrange the battery modules at their position inside the battery, and thus to realize the overall mechanical construction of the battery, and then in a subsequent step to realize the electrically conductive connections for the purpose of connecting the individual battery modules in series and/or in parallel. Since the first module connecting element and/or the second module connecting element can be arranged on one of the two end faces, on one of the two side faces or on the battery-module underside, or in particular also on the battery-module upper side, it is possible to arrange the module connecting element such that it is still accessible even after the overall mechanical construction of the battery has been effected. The electrical interconnection in this case can then be realized by the further electrically conductive connecting element. In particular, in the case of battery modules in which the total voltage is less than, for example, 60 volts d.c., only the final step, of building-up the voltage by realizing the electrically conductive connections between the individual battery modules, needs to be performed by a trained electrician having appropriate safety knowledge.

Expediently, a module connecting element in each case comprises a housing composed of an electrically insulating material. The positive voltage tap and the negative voltage tap of the battery module can thereby be electrically insulated, making it possible to avoid unwanted short circuits or electrical contacting. Furthermore, a module connecting element comprises an electrically conductive connecting portion that is arranged in the electrically insulating housing. The connecting portion is additionally connected in an electrically conductive manner to the positive or the negative voltage tap of the respective battery module. In this case, for the purpose of connecting the first battery module and the second battery module in an electrically conductive manner, a first connecting portion of the module connecting element of the first battery module and a second connecting portion of the module connecting element of the second battery module are connected to each other in an electrically conductive manner. The connection of the first connecting portion and the second connecting portion in this case is realized as a plug-in connection. In this case, for the purpose of direct electrically conductive connection, the first connecting portion may have an opening, in which the second connecting portion, realized as a plug-in element, is arranged. In addition, in this case the first connecting portion may have an opening, and the second connecting portion may have an opening that extends continuously through the housing of the module connecting element having the second connecting portion, the further electrically conductive connective element additionally being arranged such that it extends in the opening of the first connecting element and in the opening of the second connecting element. Since the second connecting portion has an opening through the housing of the module connecting element having the second connecting portion, the further electrically conductive connecting element can still connect the first connecting portion and the second connecting portion to each other in an electrically conductive manner, even after the first battery module and the second battery module have been arranged next to each other.

It is advantageous if the module connecting element is connected to the respective battery module in a materially bonded or form-fitting manner. In particular, in this case this connection may be realized as a welded, riveted or bonded connection. In addition, it is also possible for the module connecting element to be latched-in on the battery module. In particular, the housing can absorb the joining forces.

The invention additionally relates to a method for producing a battery described above. All advantages and development possibilities mentioned in connection with the battery according to the invention are also furthermore intended in this case to be applicable in connection with the method according to the invention, such that reciprocal reference may be made between the battery and the method for producing the battery.

In a method step a), a plurality of battery cells are electrically interconnected in series and/or in parallel to form a first battery module and to form a second battery module. The first battery module and the second battery module, each having a plurality of battery cells interconnected in series and/or in parallel, are thus thereby provided. In a method step b), a first module connecting element, connected to the positive voltage tap in an electrically conductive manner, and/or a second module connecting element, connected to the negative voltage tap in an electrically conductive manner, are/is arranged on the first battery module and on the second battery module. As a result, the first battery module has at least one first module connecting element or one second module connecting element, and the second battery module has at least one first module connecting element or one second module connecting element, that are in each case connected to the positive or negative voltage tap of the battery module. In a method step c), an electrically conductive connection is realized between the module connecting element of the first battery module and the module connecting element of the second battery module. The electrically conductive connection of the module connecting elements in this case is realized as a plug-in connection. This enables the first battery module and the second battery module to be interconnected to each other in series and/or in parallel in a simple manner.

Furthermore, it is advantageous if the first battery module and the second battery module are arranged next to each other. In this case, in particular, the module connecting element of the first battery module and the module connecting element of the second battery module are not connected to each other in an electrically conductive manner. It is only in a subsequent method step d) that the module connecting elements are connected to each other in an electrically conductive manner via the further electrically conductive connecting element. This has the advantage, as has already been described in connection with the battery according to the invention, that the overall mechanical construction of a battery, having a plurality of battery modules, can be effected first, and the electrically conductive connections between the individual battery modules can be effected in a subsequent step, for the purpose of building-up the voltage.

In particular, the invention relates to a method in which, in method step a), a plurality of battery modules, having a plurality of battery cells that are electrically interconnected in series and/or in parallel, is additionally provided. In method step b) in this case, a first module connecting element, connected in an electrically conductive manner to the positive voltage tap, and/or a second module connecting element, connected in an electrically conductive manner to the negative voltage tap, are/is also to be arranged, respectively, on the plurality of battery modules. Furthermore, in method step c), the battery modules are first arranged next to each other to form the battery. In the method step d), respectively two module connecting elements of adjacently arranged battery modules are then connected to each other in an electrically conductive manner by respectively one further electrically conductive connecting element.

### BRIEF DESCRIPTION OF THE DRAWINGS

Exemplary embodiments of the invention are represented in the drawings and explained in greater detail in the description that follows.

There are shown

FIG. 1a an embodiment of a battery module having a first arrangement of a module connecting element,

FIG. 1b an embodiment of a battery module having a second arrangement of a module connecting element,

FIG. 1c an embodiment of a battery module having a third arrangement of a module connecting element,

FIG. 2 a schematic top view of a battery according to the invention,

FIG. 3a an embodiment of a plug-in connection for realizing a direct electrically conductive connection between two module connecting elements, and

FIG. 3b an embodiment of a plug-in connection for realizing an electrically conductive connection between two module connecting elements by means of a further electrically conductive connecting element.

### DETAILED DESCRIPTION

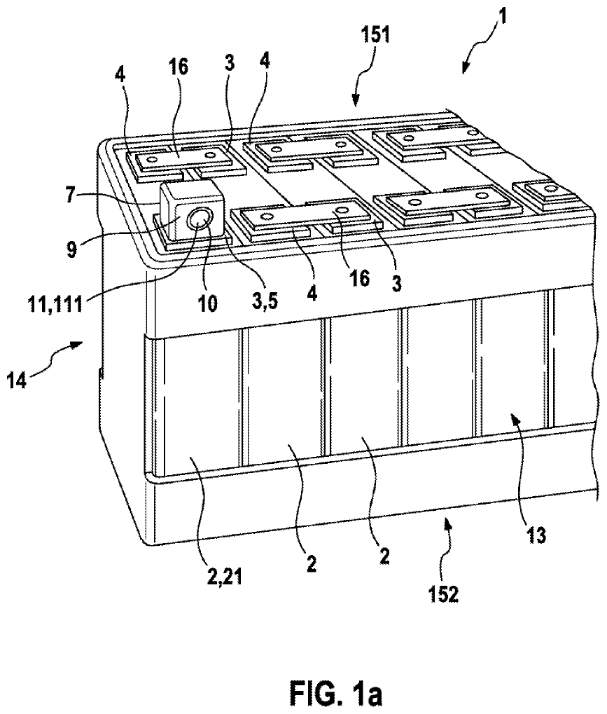

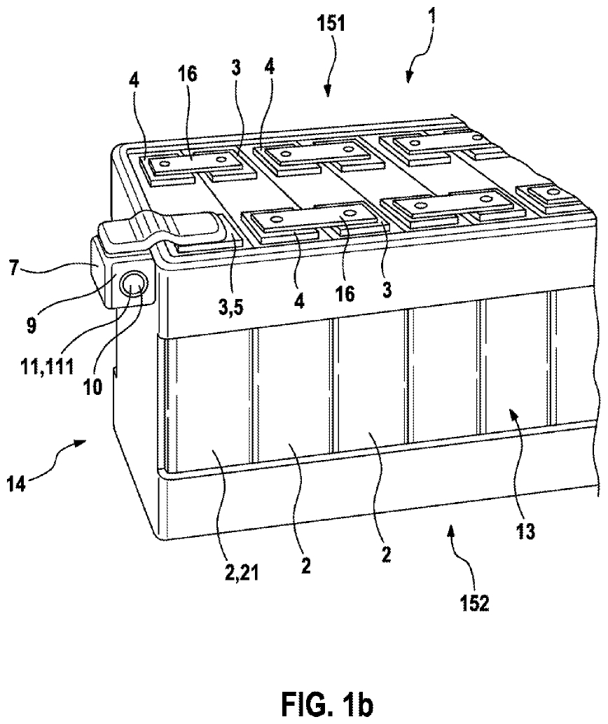

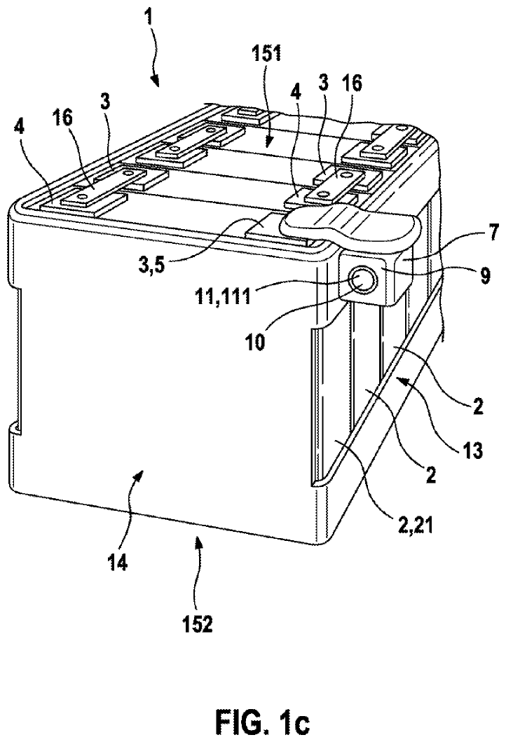

FIGS. 1a to 1c each show embodiments of a battery module 1 having a plurality of battery cells 2, arranged next to each other, which are preferably identical. The battery cells 2 each have a positive voltage tap 3 and a negative voltage tap 4. For the purpose of interconnecting the individual battery cells 2 in series, as shown in FIGS. 1a to 1c, a positive voltage tap 3 of a battery cell 2 and a negative voltage tap 4 of an adjacent battery cell 2 are connected to each other in an electrically conductive manner. This electrically conductive connection may be effected by means of cell connectors 16 known from the prior art.

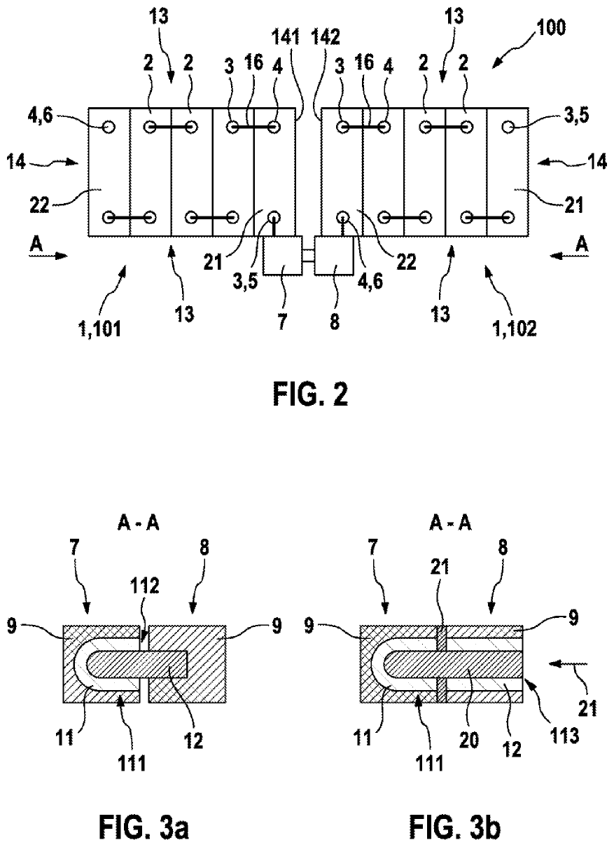

In the case of the serial interconnection of the battery cells 2, the positive voltage tap 3 of a first battery cell 21 and the negative voltage tap 4 of a last battery cell 22 is not connected, for example by means of a cell connector 16, to an adjacent battery cell 2 of the same battery module 1. The first battery cell 21 and the last battery cell 22 refers, respectively, to one of the two outer of the battery cells 2 of the battery module 1 that are arranged next to each other, as is also intended to be illustrated by FIG. 2.

The positive voltage tap 3 of the first battery cell 21 simultaneously forms the positive voltage tap 5 of the battery module 1, and the negative voltage tap 4 of the last battery cell 22 simultaneously forms the negative voltage tap 6 of the battery module 1.

As can be seen from FIGS. 1a to 1c, the battery module 1 additionally has a first module connecting element 7, and a second module connecting element 8 that is not shown in FIGS. 1a to 1c. The positive voltage tap 6 of the battery module 1 is connected in an electrically conductive manner to the first module connecting element 7. The negative voltage tap 6 of the battery module 1 is connected in an electrically conductive manner to the second module connecting element 8.

The first module connecting element 7 and the second module connecting element 8 each have a housing 9, of an electrically insulating material. Furthermore, a module connecting element 7, 8 comprises an electrically conductive connecting portion 10, described in greater detail below with reference to FIGS. 3a and 3b.

For the purpose of realizing an electrically conductive connection between a first battery module 101 and a second battery module 102, a first connecting portion 11 of the module connecting element 7, 8 of the first battery module 101 and a second connecting portion 12 of the module connecting element 7, 8 of the second battery module 102 are connected to each other in an electrically conductive manner.

The battery module 1 has substantially two mutually opposite side faces 13, two mutually opposite end faces 14, a battery-module upper side 151 and, opposite the battery-module upper side 151, a battery-module underside 152.

As has already been described, the first module connecting element 7 and/or the second module connecting element 8 may be arranged on one of the two side faces 13, on one of the two end faces 14, or on the battery-module upper side 151, and in particular also on the battery-module underside 152, to enable the required spatial arrangement of the battery modules 1 to be effected.

The embodiment of a battery module 1 shown in FIG. 1a is advantageous, for example, if the battery module 1 is arranged with a side face 13 adjacent to a side face 13 of another battery module 1, wherein the first module connecting element 7 is arranged on the battery-module upper side 151 and wherein, for example, a further element of the battery that is not shown here is to be arranged on the side face 14 adjacent to the first module connecting element 7, such that there is no space available here. Furthermore, in such a case, if the battery module 1 is arranged with a side face 13 adjacent to a side face 13 of another battery module 1, with no space being available on the battery-module upper side 151, for example because of the arrangement of a further battery module 1, the first module connecting element 7 can also be arranged on an end face 14, as shown in FIG. 1b.

The embodiment shown in FIG. 1c is advantageous if the battery module 1 is arranged with an end face 14 adjacent to an end face 14 of another battery module 1. In this case, the first module connecting element 7 is arranged on a side face 13. In addition, in such a case the module connecting element 7 can also be arranged on the battery-module upper side 151 or the battery-module underside 152, which is not shown here.

As can be seen in FIGS. 1a to 1c, the connecting portion 10 of the first module connecting element 7 is realized as an opening 111 that, in particular, may also be realized so as to extend continuously through the housing 9 of the first module connecting element 7, as explained in greater detail in the following.

FIG. 2 shows a schematic top view of a battery 100 according to the invention.

The battery 100 has a first battery module 101 and a second battery module 102 which, as already described in FIGS. 1a to 1c, each have a plurality of battery cells 2.

The battery cells 2 of the first battery module 101 and the battery cells 2 of the second battery module 102 are each electrically connected to each other in series by means of cell connectors 16. In this case, a positive voltage tap 3 of a battery cell 2 is connected in an electrically conductive manner to a negative voltage tap 4 of an adjacent battery cell 2. It is also conceivable for the battery cells 2 to be electrically connected to each other in parallel. Furthermore, the positive voltage tap 3 of the first battery cell 21 of the first battery module 101 is not connected in an electrically conductive manner to the voltage tap 3, 4 of an adjacent battery cell 2 of the first battery module 101, and thus forms the positive voltage tap 5 of the first battery module 101. The negative voltage tap 4 of the last battery cell 22 of the first battery module 101 is not connected in an electrically conductive manner to the voltage tap 3, 4 of an adjacent battery cell 2 of the first battery module 101, and thus forms the negative voltage tap 6 of the first battery module 102. Furthermore, the negative voltage tap 4 of the last battery cell 22 of the second battery module 102 is not connected in an electrically conductive manner to the voltage tap 3, 4 of an adjacent battery cell 2 of the second battery module 102, and thus forms the negative voltage tap 6 of the second battery module 102. The positive voltage tap 3 of the first battery cell 21 of the second battery module is not connected in an electrically conductive manner to the voltage tap 3, 4 of an adjacent battery cell 2 of the second battery module 102, and thus forms the positive voltage tap 5 of the second battery module 102.

It can additionally be seen from FIG. 2 that the first module connecting element 7 is connected in an electrically conductive manner to the positive voltage tap 5 of the first battery module 101, and the second module connecting element 8 is connected in an electrically conductive manner to the negative voltage tap 6 of the second battery module 102.

The first battery module 101 is arranged with a first end face 141 adjacent to a second end face 142 of the second battery module 102. The first module connecting element 7 and the second module connecting element 8 are each respectively arranged on a side face 13 of the first battery module 101 and of the second battery module 102. In this case the first module connecting element 7 and the second module connecting element 8 are connected to each other in an electrically conductive manner, the electrically conductive connection of the module connecting elements 7, 8 being realized as a plug-in connection.

FIGS. 3a and 3b each show, in schematic form, embodiments of an electrically conductive connection, realized as a plug-in connection, of the first module connecting element 7 and second module connecting element 8, according to the section A-A shown in FIG. 2.

FIG. 3a shows a first embodiment, in which the module connecting elements 7, 8 are directly connected to each other in an electrically conductive manner. In this case, the first module connecting element 7 and the second module connecting element 8 each have a housing 9 of an electrically insulating material. The first module connecting element 7 additionally comprises a first connecting portion 11, which is composed of an electrically conductive material and in addition is connected in an electrically conductive manner to the positive voltage tap 5 of the first battery module 101. As shown by FIG. 3a, the first connecting portion 11 comprises an opening 111. The second module connecting element 8 comprises a second connecting portion 12, which is composed of an electrically conductive material and in addition is connected in an electrically conductive manner to the negative voltage tap 6 of the second battery module 102. As shown by FIG. 3a, the second connecting portion 12 comprises a projection 112, which projects out of the housing 9 and serves as a plug-in element. For the purpose of realizing an electrically conductive connection between the first connecting portion 11 and the second connecting portion 12, the projection 112 is inserted into the opening 111 in such a manner that an electrically conductive connection is realized as a result of contacting between the first connecting portion 11 and the second connecting portion 12.

FIG. 3b shows a second embodiment, in which a further electrically conductive connecting element 20 connects the module connecting elements 7, 8 to each other in an electrically conductive manner. In this case, the first module connecting element 7 and the second module connecting element 8 each have a housing 9 of an electrically insulating material. The first module connecting element 7 additionally comprises the first connecting portion 11, which is composed of an electrically conductive material and in addition is connected in an electrically conductive manner to the positive voltage tap 5 of the first battery module 101. As shown by FIG. 3b, the first connecting portion 11 comprises an opening 111. The second module connecting element 8 additionally comprises the second connecting portion 12, which is composed of an electrically conductive material and in addition is connected in an electrically conductive manner to the negative voltage tap 6 of the second battery module 102. As shown by FIG. 3b, the second connecting portion 12 comprises an opening 113 that extends continuously through the housing 9 of the second module connecting element 8. The further electrically conductive connecting element 20 connects the first connecting portion 11 and the second connecting portion 12 in an electrically conductive manner. The further electrically conductive connecting element 20 in this case is arranged in the opening 111 of the first connecting portion 11 and in the opening 113 of the second connecting portion 12. The realization of the second connecting portion 12 as an opening 113 extending continuously through the housing 9 has the advantage, in particular, that the first battery module 101 and the second battery module 102 can be arranged next to each other without realizing an electrically conductive connection between the first connecting portion 11 and the second connecting portion 12. The electrically conductive connection can then be realized in a further step, since the further electrically conductive connecting element 20 can be inserted in the shown direction 21. In addition, it is clearly possible for the first connecting portion 11 also to be realized as an opening extending continuously through the housing 9 of the first connecting element 7, such that insertion contrary to the shown direction 21 is also possible.

In order, in the case of the first battery module 101 being arranged next to the second battery module 102, to prevent an electrically conductive connection from being realized between the first connecting portion 11 and the second connecting portion 12 before the further electrically conductive connecting element 20 is inserted, an insulation element 21, which serves to effect electrical insulation and prevents unwanted contacting, may be arranged between the first module connecting element 7 and the second module connecting element 8.

1. A battery having at least two battery modules (1, 101, 102), wherein a battery module (1, 101, 102) comprises, respectively, a plurality of battery cells (2), and in addition has a positive voltage tap (5) and a negative voltage tap (6), wherein
a first module connecting element (7) is connected in an electrically conductive manner to the positive voltage tap (5), and/or a second module connecting element (8) is connected in an electrically conductive manner to the negative voltage tap (6), wherein a module connecting element (7, 8) of a first battery module (101) and a module connecting element (7, 8) of a second battery module (102) are connected in an electrically conductive manner, characterized in that the electrically conductive connection of the module connecting elements (7, 8) is a plug-in connection.

2. The battery as claimed in claim 1, characterized in that
the module connecting elements (7, 8) are directly connected to each other in an electrically conductive manner.

3. The battery as claimed in claim 1, characterized in that,
for the purpose of interconnecting the first battery module (101) and the second battery module (102) in series, the first module connecting element (7) of the first battery module (101) and the second module connecting element (8) of the second battery module (102) are connected in an electrically conductive manner, or the second module connecting element (8) of the first battery module (101) and the first module connecting element (7) of the second battery module (102) are connected in an electrically conductive manner.

4. The battery as claimed in claim 1, wherein
a battery module (1, 101, 102) in each case has substantially two mutually opposite end faces (14), two mutually opposite side faces (13), and one battery-module underside (152) that is opposite one battery-module upper side (151), wherein
the positive voltage tap (5) and/or the negative voltage tap (6) of the battery module (1, 101, 102) are/is arranged on the battery-module upper side (151), characterized in that
the first module connecting element (7) and/or the second module connecting element (8) are/is arranged on the battery-module underside (152), on one of the two end faces (14) or on one of the two side faces (13).

5. The battery as claimed in claim 4, wherein
the first battery module (101) and the second battery module (102) are arranged next to each other, and one of the two end faces (14) of the first battery module (101) is arranged directly adjacently to one of the two end faces (14) of the second battery module (102), characterized in that the first module connecting element (7) and/or the second module connecting element (8) are/is arranged on a side face (13).

6. The battery as claimed in claim 4, wherein
the first battery module (101) and the second battery module (102) are arranged next to each other, and one of the two side faces (13) of the first battery module (101) is arranged directly adjacently to one of the two side faces (13) of the second battery module (102), characterized in that the first module connecting element (7) and/or the second module connecting element (8) are/is arranged on an face (14).

7. The battery as claimed in claim 4, wherein
the first battery module (101) and the second battery module (102) are arranged next to each other, and the battery-module upper side (151) of the first battery module (101) is arranged directly adjacently to the battery-module underside (152) of the second battery module (102), characterized in that the first module connecting element (7) and/or the second module connecting element (8) are/is arranged on an end face (14) or on a side face (13).

8. The battery as claimed in claim 1, wherein
a module connecting element (7, 8) in each case comprises a housing (9), composed of an electrically insulating material, arranged in which is an electrically conductive connecting portion (10, 11, 12) that is additionally connected in an electrically conductive manner to the positive voltage tap (5) or to the negative voltage tap (6) of the respective battery module (1, 101, 102), wherein, for the purpose of connecting the first battery module (101) and the second battery module (102) in an electrically conductive manner, a first connecting portion (11) of the module connecting element (7) of the first battery module (101) and a second connecting portion (12) of the module connecting element (8) of the second battery module (102) are connected to each other in an electrically conductive manner, characterized in that, for the purpose of direct electrically conductive connection, the first connecting portion (11) has an opening (111), in which the second connecting portion (12), realized as a plug-in element (112), is arranged, or the first connecting portion (11) has an opening (111), and the second connecting portion (12) has an opening (113) that extends continuously through the housing (9) of the module connecting element (8) having the second connecting portion (12), wherein the further electrically conductive connective element (20) is arranged such that it extends in the opening (111) of the first connecting portion (11) and in the opening (113) of the second connecting portion (12).

9. The battery as claimed in claim 1, characterized in that
the module connecting element (7, 8) is connected to the respective battery module (1, 101, 102) in a materially bonded or form-fitting manner.

10. A method for producing a battery (100) as claimed in claim 1, having the following method steps:
a) electrically interconnecting a plurality of battery cells (2), in series and/or in parallel to form a first battery module (101) and to form a second battery module (102);
b) arranging a first module connecting element (7), connected to the positive voltage tap (5) in an electrically conductive manner, and/or a second module connecting element (8), connected to the negative voltage tap (6) in an electrically conductive manner, on the first battery module (101) and on the second battery module (102); and
c) providing an electrically conductive connection between the module connecting element (7, 8) of the first battery module (101) and the module connecting element (7, 8) of the second battery module (102), wherein the electrically conductive connection of the module connecting elements (7, 8) is a plug-in connection.

11. The method as claimed in claim 10, characterized in that
the first battery module (101) and the second battery module (102) are arranged next to each other, and then in a further method step d) the module connecting elements (7, 8) are connected to each other in an electrically conductive manner via the further electrically conductive connecting element (20).

12. The method as claimed in claim 11, wherein,
in method step a), a plurality of battery modules (1, 101, 102), having a plurality of battery cells (2) that are electrically interconnected in series and/or in parallel, is furthermore provided, and
in method step b), a first module connecting element (7), connected in an electrically conductive manner to the positive voltage tap (5), and/or a second module connecting element (8), connected in an electrically conductive manner to the negative voltage tap (6), are/is furthermore arranged, respectively, on the plurality of battery modules (1, 101, 102), and the method step c) comprises firstly arranging the battery modules (1, 101, 102) next to each other to form the battery (100), and then, in the method step d), respectively two module connecting elements (7, 8) of adjacently arranged battery modules (1, 1010, 102) are connected to each other in an electrically conductive manner by respectively one further electrically conductive connecting element (20).

13. The battery as claimed in claim 1, wherein
a further electrically conductive connecting element (20) connects the module connecting elements (7, 8) electrically to each other.

14. The battery as claimed in claim 1, characterized in that,
for the purpose of interconnecting the first battery module (101) and the second battery module (102) in parallel, the first module connecting element (7) of the first battery module (101) and the first module connecting element (7) of the second battery module (102) are connected in an electrically conductive manner, or the second module connecting element (8) of the first battery module (101) and the second module connecting element (8) of the second battery module (102) are connected in an electrically conductive manner.

15. The battery as claimed in claim 1, characterized in that
the module connecting element (7, 8) is connected to the respective battery module (1, 101, 102) in a welded, riveted, bonded or latched-in manner.
